(19) United States
(12) Patent Application Publication
(10) Pub. No.: US 2002/0029671 A1
(43) Pub. Date: Mar. 14, 2002

(54) Stacking apparatus

(75) Inventors: Gunter Gammerler, Gelting (DE); Ronald Meisel, Kochel am See (DE)

Correspondence Address: FITCH EVEN TABIN AND FLANNERY, 120 SOUTH LA SALLE STREET, SUITE 1600, CHICAGO, IL, 60603-3406, US

(73) Assignee: Gammerler AG

(21) Appl. No.: 09/923,159

(22) Filed: Aug. 6, 2001

(30) Foreign Application Priority Data
Sep. 12, 2000 (DE) 100 45 062.8

(51) Int. Cl. B26D 1/15

(52) U.S. Cl. 83/23; 83/29; 83/35

(57) ABSTRACT

A stacking apparatus for paper products comprises a supplier of an overlapping stream of paper products and a plurality of receiver elements to form a layer. A rotation device is arranged beneath the receiver elements, with the orientation of the supplied printed products being rotated through 90° with respect to the orientation of the layer on exiting the further receiver element.

### FIELD OF THE INVENTION

The present invention relates to a stacking apparatus for paper products for the stacking and simultaneous cutting of paper products. Stacking apparatuses only are known from the prior art under the name of “cross stackers” and serve, on the one hand, to stack paper products supplied in an overlapping stream into individual layers and, on the other hand, to form stacks from the layers formed which each have layers arranged rotated through 180°. If the individual paper products are provided with a fold, such an offset arrangement of stacks of layers is usually necessary in order to obtain an end stack which is aligned essentially in cuboid shape. If no fold is present or if it is not distinct enough, the offset arrangement of stacks can be omitted.

### BACKGROUND OF THE INVENTION

In conventional print post-processing, the already folded printed products supplied in an overlapping stream are usually first trimmed at two opposite sides (head cut and foot cut). The relative orientation of the individual printed products to the conveying direction is subsequently turned through 90° in a corner deflection so that a side trim can be carried out at the remaining side opposite the fold. Subsequent to this, it can again be necessary to rotation the relative orientation of the printed products through 90° so that a proper cross-laying can take place in the cross-layer.

### SUMMARY OF THE INVENTION

It is the object of the present invention to further develop a cross-layer in accordance with the preamble of claim 1 such that the space and plant requirements needed for a further processing can be reduced.

This object is satisfied by the features of claim 1 where, in accordance with the invention, a cutting device is provided between the stack chamber and the discharge, for example an ejector, with which a trimming of a completely formed layer can be carried out.

An apparatus is thus provided in accordance with the invention with which individual layers can be formed, or also stacks from layers, with, however, a trimming of a completely formed layer being carried out simultaneously. In this way, the space and plant requirements for a print post-treatment can be quite substantially reduced since no separate cutting unit is required for the trimming and since a corner deflection for the overlapping stream for the reorientation of the printed products relative to the conveying direction can be completely omitted. The invention is based on the recognition that a trimming of a complete layer can advantageously be carried out simultaneously within a stacking apparatus so that a separate cutting unit can be omitted.

Since the orientation of the supplied printed products is frequently rotated through 90°—considered relative to the respective conveying direction—when compared to the orientation of the layer on exiting the further receiver element in a stacking apparatus and also in a cross-layer, an otherwise required corner deflection can be omitted by the combination of such an apparatus with a cutting device. This not only reduces the space requirement and the plant requirement for the print post-treatment, but also the waste since every kind of deflection of a product stream comes with a certain waste risk—particularly at the start-up of production.

The cutting stacking apparatus of the invention provides the possibility for the first time within one and the same machine of simultaneously forming layers and carrying out a trimming of a complete layer at at least one side without the cycle times being reduced. At the same time, the use of an otherwise necessary corner deflection can be omitted.

Advantageous embodiments of the invention are described in the description, the drawings and the dependent claims.

It is particularly advantageous if the supplier of the cutting stacking apparatus has a further cutting device with which a trimming of the overlapping stream of paper products can be carried out. In this embodiment, the head and foot trimming can, for example, be carried out in the region of the supplier, while the still lacking side trimming can be carried out layer-wise in the region of the first cutting device. When this embodiment is used, separate cutting units and corner deflections can be completely omitted. At the same time, the space requirements are substantially reduced in comparison with conventional plants.

The cutting devices provided in the cutting stacking apparatus can have at least one rotation cutting knife or at least one guillotine blade. Rotation cutting knives have proved their value for the cutting of an overlapping stream. Such rotation cutting knives can also be used for the cutting of a complete layer. It is also possible to use guillotine blades for this as an alternative. The use of milling cutters is likewise possible.

A rotation device is preferably provided subsequent to the stacking basket in the cutting stacking apparatus. A cross-stacking of the individual layers can take place in this way.

In accordance with a further advantageous embodiment, at least two discharge devices are disposed downstream of the rotation device of the cross stacker which extend at an angle of 90° to one another in a plan view. Since the rotation device of the cutting stacking apparatus can be freely rotated around its axis, the completely formed stacks which are located on the rotation device can generally be ejected in any direction. It is in particular possible to eject the stacks in two directions arranged mutually offset by 90° so that the completely formed stacks can be discharged in different directions. This presents the possibility of conveying the completely formed stacks out of the cutting stacking apparatus at different points so that intermediate storage areas are provided in this way.

In accordance with a further advantageous embodiment, cutting devices are provided at two sides of the further receiver element and a trimming of a formed layer can be carried out with each of these. In this embodiment, the cycle time of the cutting stacking apparatus can be increased even further since two separate cutting devices are provided which are downstream of the stacking chamber.

If can be advantageous for fast cycle times to briefly guide a formed layer into the region of the cutting device, to cut it and to subsequently guide it back again for further transportation. Even shorter cycle times result if a completely formed layer is conveyed into the cutting device and is conveyed out of the cutting device again in the same direction, since here the return conveying of the layer can be omitted.

Depending on the design of the cutting stacking apparatus, it can be advantageous to have the cutting plane of the cutting device extend parallel to the conveying direction of the layer on exiting the stacking chamber. It can, however, also be favorable, particularly when a guillotine blade is used, to have the cutting plane of the cutting device extend perpendicular to the conveyor direction of the layer.

In accordance with a further advantageous embodiment of the invention, a retractable buffer is provided after the cutting device with the aid of which a cut layer can be dropped into the rotation device. Shorter cycle times can be achieved with such a buffer with a gentle product treatment.

The present invention is described in the following purely by way of example by means of advantageous embodiments with reference to the enclosed drawings.

### BRIEF DESCRIPTION OF THE DRAWINGS

FIG. 1 shows a first embodiment of a cutting stacking apparatus in a view in accordance with the line A-A of FIG. 2;

FIG. 2 shows a plan view of the cutting stacking apparatus of FIG. 1;

FIG. 3 shows a cut-away side view of the cutting stacking apparatus of FIGS. 1 and 2 along the line B-B of FIG. 2;

FIG. 4 shows a further embodiment of a cutting stacking apparatus in accordance with a cut-away side view along the line A-A of FIG. 5;

FIG. 5 shows a plan view of the cutting stacking apparatus of FIG. 4;

FIG. 6 shows a cut-away side view of the cutting stacking apparatus of FIGS. 4 and 5 along the line B-B of FIG. 5;

FIG. 7 shows a further embodiment of a cutting stacking apparatus in a view corresponding to FIG. 1; and

FIG. 8 shows a schematic side view of a further embodiment of a cutting stacking apparatus.

### DETAILED DESCRIPTION OF THE PREFERRED EMBODIMENTS

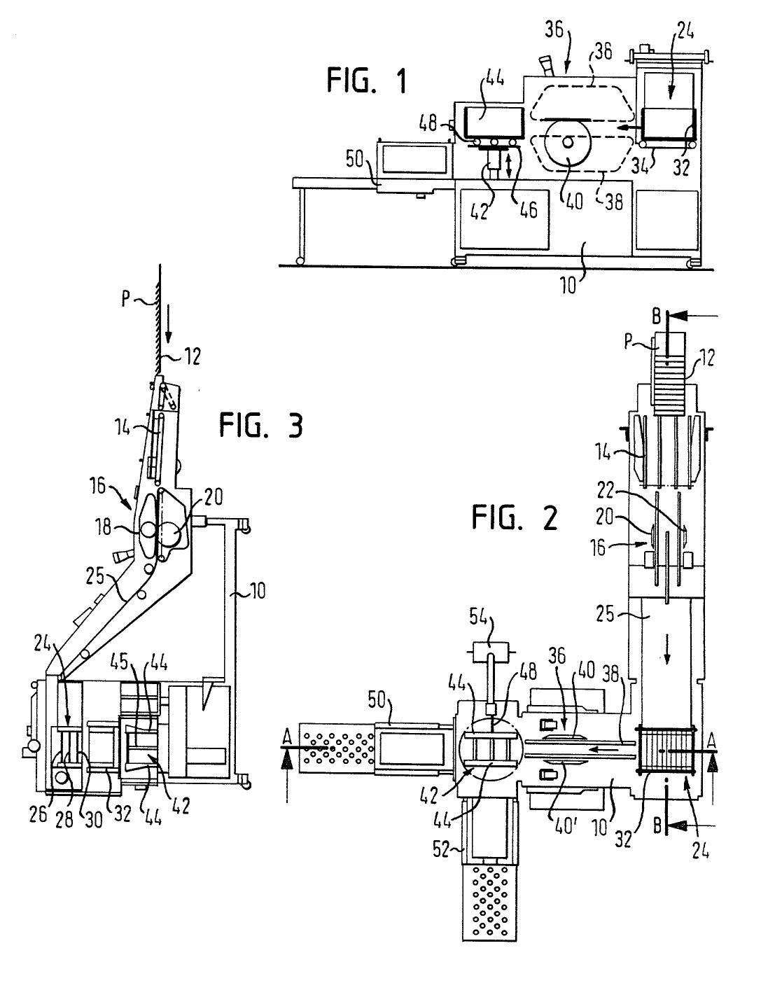

FIGS. 1 to 3 show a first embodiment of a cutting stacking apparatus of the invention which has a base frame 10 on which the individual components are assembled. A supplier 12 (FIGS. 2 and 3) serves for the supply of an overlapping stream of already folded paper products P which, in the embodiment shown, are supplied transversely to the conveying direction. The reference numeral 14 stands for synchronized fine-tuning belts which provide a precise longitudinal orientation of the product stream even for thin products.

Subsequent to the fine-tuning belts 14, the overlapping flow of paper products P runs through a cutting apparatus 16 in which the overlapping stream is held by means of compression belts 18 (FIG. 3) and trimmed with the aid of rotation cutting knives 20, 22 (FIG. 2). A head and foot trimming of the individual paper products P of the overlapping stream is carried out in this way.

After running through the cutting device 16, the overlapping stream, which is already trimmed at two parallel sides, is conveyed upwardly via a conveyor belt 25 in the direction of a stacking chamber 24 into which the overlapping stream flows. A total of three receiver elements each in the form of a rake pair 26, 28, 30 and arranged one over the other are located in the region of the stacking chamber 24 (FIG. 3). The individual rakes of each rake pair can be moved toward and away from one another in a known manner with the aid of setting cylinders so that a layer can be formed or further formed on each rake pair 26, 28, 30.

An intermediate basket 32 is provided beneath the lowest rake pair 30 and conveyor belts 34 are arranged at its bottom which convey a fully formed layer in the direction of a further cutting device 36. A trimming of a completely formed layer is carried out at the third side, opposite the fold, in the cutting device 36. For this purpose, compression belts 38 are provided in the embodiment represented in FIGS. 1 to 3 which compress the layer while it is trimmed at the side by a rotation cutting knife 40. The reference numeral 40′ merely designates an alternative position for the rotation cutting knife 40.

After running through the cutting device 36, the layer trimmed at three sides is conveyed to a rotation device 42 which can be rotated around a vertical axis and which can additionally be vertically raised and lowered. The rotation device 42 is provided with two parallel guides 44 between which a completely trimmed layer is conveyed. A buffer 48 in the form of a rake displaceable with the aid of a setting cylinder is provided beneath and above a tray 46 of the rotation device 42. The buffer 48 serves the provisional storing of a completely trimmed layer after a first or multiple layers have already been placed on the tray 46.

Respective discharge devices 50, 52 are provided at two sides of the rotation device 42 which are arranged offset to one another by 90° in a plan view and which discharge a stack, consisting of layers each arranged offset to one another by 180°, from the cutting stacking apparatus formed as a cross-layer. The reference symbol 54 designates a control of the cross-layer. The reference symbol 45 designates a lowerable ejector which ejects a completely formed stack from the rotation device.

The function of the cross stacker represented in FIGS. 1 to 3 is described below.

The overlapping stream of paper products P supplied via the supplier 12 is precisely aligned in the region of the fine-tuning belts 14 and subsequently enters into the cutting device 16 in which a head and foot trimming of the individual paper products is carried out with the aid of the rotation cutting knives 20, 22. The overlapping stream is subsequently guided upwardly to the stacking chamber 24 with the aid of the conveyor belt 25. The individual paper products P there fall into the intermediate basket and there initially onto the first rake pair 26.

After the first rake plane, which is formed by the first rake pair 26, has been filled, the rake pair 26 opens and the already formed layer falls onto the second rake plane located below which is formed by the closed rake pair 28. After the layer has been further formed by paper products falling into the intermediate basket 32, the second rake pair 28 is opened so that the layer can fall onto the third, closed rake pair 30. Once the layer has reached the desired height, the first rake pair 26 is closed and the third rake pair 30 opened so that the completely formed layer falls into the intermediate basket 32. The layer is transported from there to the cutting device 36, optionally previously oriented again, with the aid of the conveyor belt 34 and compressed with the aid of the compression belts 38 and simultaneously trimmed at the side at the product side opposite the fold with the aid of the rotation cutting knife 40.

As can be seen in particular from FIG. 2, the orientation of the individual paper products P relative to the supply direction is swiveled through 90° prior to running into the stacking chamber 24 and after running out of the stacking chamber.

The completely trimmed layer is subsequently conveyed to the tray 46 of the rotation device 42 with the aid of conveyor belts (not shown). The rotation device 42 is thereupon rotated through 180° and lowered so far that the layer located on the tray 46 is below the buffer 48.

The buffer 48 is subsequently moved out so that a subsequently supplied layer can be placed on the buffer 48. This layer falls onto the layer located below it by a retraction of the rake of the buffer 48 so that overall two layers have already been placed down offset by 180°. Once the stack located at the tray 46 has reached the desired final height, the stack is conveyed to one of the two discharge devices 50, 52 with the aid of the ejector 45. The stack is removed from there with the aid of palleting grippers, with a strapping or covering also being able to be provided.

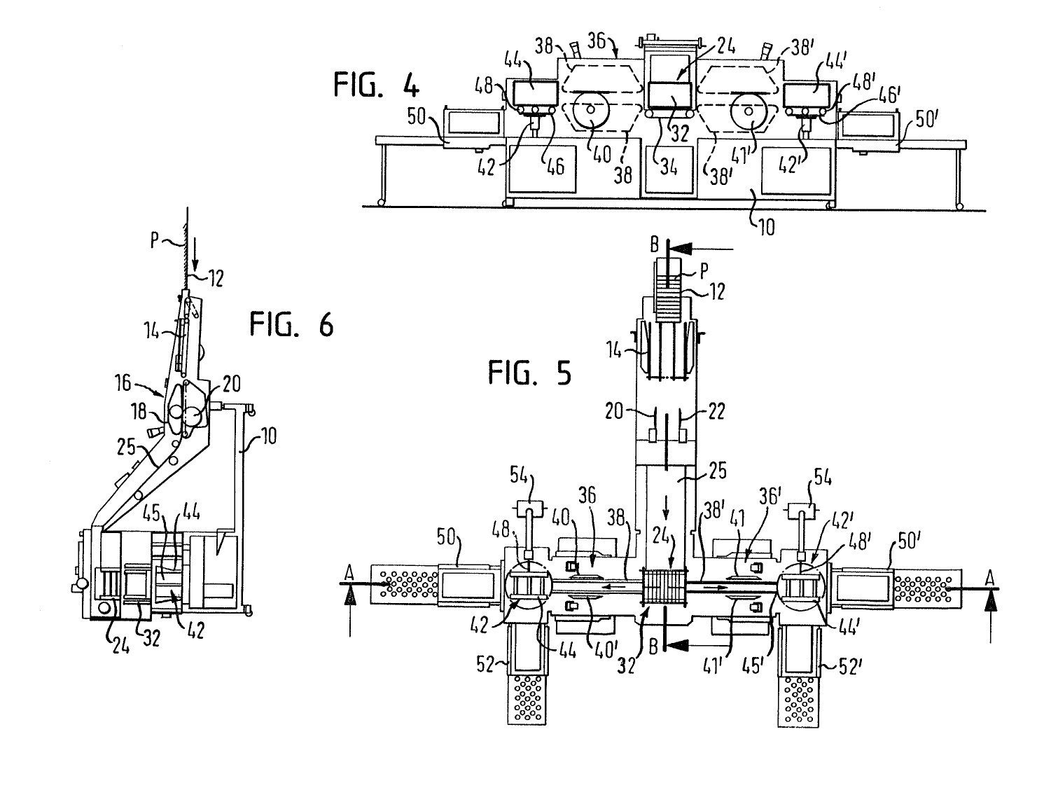

The embodiment shown in FIGS. 4 to 6 is described below, with the same reference numerals being used for the same or comparable elements.

The embodiment of the invention shown in FIGS. 4 to 6 is likewise a cross-layer in which a respectively identical arrangement is provided at two opposite sides of the stacking chamber 24 consisting in each case of a cutting device 36, 36′; a rotation device 42, 42′; and discharge devices 50, 50′ and 52, 52′. The setup of the additional units, which are marked with dotted reference numerals, is identical to that of FIGS. 1 to 3 so that a more detailed description is dispensed with.

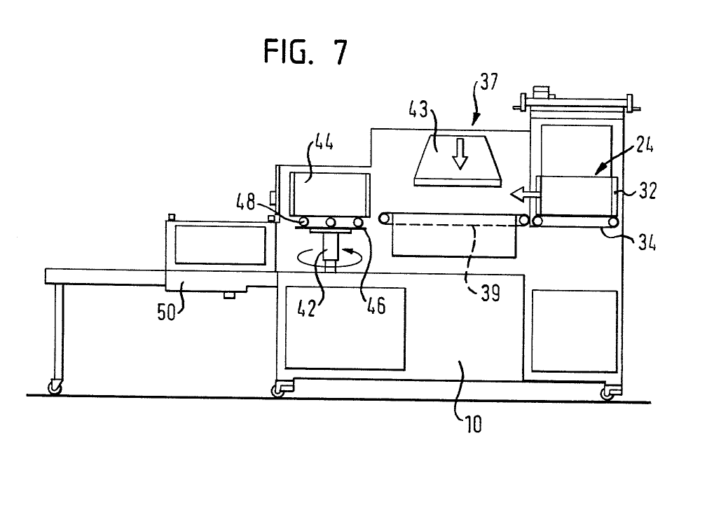

In FIG. 7, a view comparable to FIG. 1 of a further embodiment of the invention in the form of a cross-layer is shown, with the same reference numerals being used for the same or comparable parts.

In this alternative embodiment, a cutting device 37 is provided, in place of cutting device 36, which has, in place of a rotation cutting knife, a guillotine knife 43 which trims a completely formed layer at one side. A conveyor belt 39 is provided for the further transport of the layer. A compression device (not shown) serves to fix the layer during cutting.

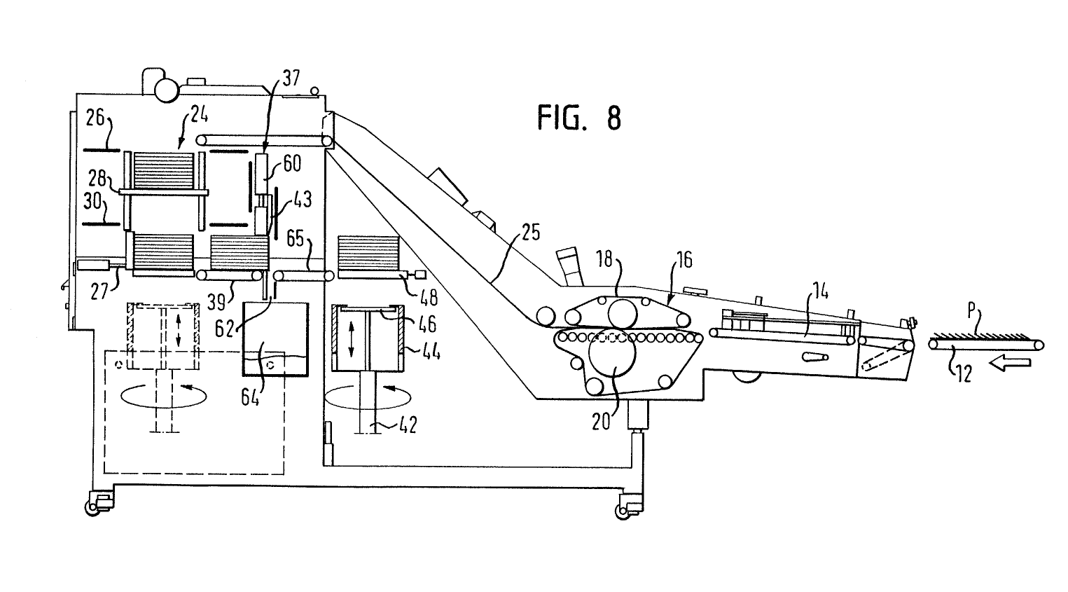

Finally, FIG. 8 shows a schematic side view of a further embodiment of a cutting stacking apparatus in the form of a cross-layer. The same reference numerals are also used for the same or comparable elements here.

In the embodiment shown in FIG. 8, the overlapping stream of paper products P is first supplied from a supplier 12 and subsequently runs through the cutting device 16 in which a head and foot trimming of the paper products P is carried out with the aid of a rotation cutting knife 20. The overlapping stream is subsequently led with the aid of a conveyor belt 25 to a stacking chamber 24 in which—as also in the preceding embodiments—three rake pairs 26, 28, 30 are arranged. A transfer unit 27 is provided beneath the stacking chamber 24 which transfers a completely formed layer onto a conveyor belt 39 in the region of a cutting device 37.

The layer is compressed in the region of the cutting device 37 with the aid of a compressing plunger 60 and subsequently trimmed at one side with the aid of a guillotine blade 43. The cutting plane here is transverse to the conveying direction of the layer. The cut-off remainder can fall through a shaft 62 into a container 64, whereupon, after the retraction of the guillotine blade 43 and the release of the compressing plunger 60, the layer can be conveyed with the aid of a further conveyor belt 65 directly onto a tray 46 of a rotation device 42 or onto a waiting station 48. The cross-laying of the individual layers takes place here in the same manner as in the previously described embodiments.

As an alternative to the said embodiment of FIG. 8, it is also possible to provide the rotation device 46 directly beneath the transfer unit 27. In this case, after the cutting procedure, the cut layer can be conveyed back to the transfer unit 27 by the convey belt 39 and from there onto the rotation device.

In addition to the said horizontal transport of the layer from the stacking shaft, it is also possible to remove the individual layers from the stacking chamber in a vertical direction.

What is claimed is:

1. A cutting stacking apparatus for paper products comprising
a supplier (12) for the supply of an overlapping stream of paper products (P);
a stacking chamber (24) with a first (26) and at least one further receiver element (28, 30) for the forming of at least one layer; and
a discharger (45, 45′; 50, 50′; 52, 52′) for the leading out of the at least one layer from the apparatus; and
a cutting device (36, 36′, 37) which is provided between the stacking chamber (24) and the discharger (45, 45′; 50, 50′; 52, 52′) and with which a trimming of a completely formed layer can be carried out.

2. An apparatus in accordance with claim 1, wherein—considered relative to the conveying direction—the orientation of the supplied printed products (P) is rotated through 90° with respect to the orientation of the layer on exiting the stacking chamber (24).

3. An apparatus in accordance with claim 1, wherein a further cutting device (16) is associated with the supplier (12) and a trimming of the overlapping stream of paper products (12) can be carried out with this.

4. An apparatus in accordance with claim 1, wherein the cutting device (16; 36, 36′, 37) has at least one rotation cutting knife (20, 22) or at least one guillotine blade (43).

5. An apparatus in accordance with claim 1, wherein a rotation device (42, 46; 42′, 46′) is provided after the stacking chamber (24) in order to rotate the formed layer through 180°.

6. An apparatus in accordance with claim 5, wherein at least two discharge units (50, 52; 50′, 52′) are disposed downstream of the rotation device (42, 46; 42′, 46′) which extend in a plan view at an angle to one another of in particular 90°.

7. An apparatus in accordance with claim 1, wherein cutting devices (36, 36′, 37) are provided at two sides of the stacking chamber (24) with which in each case a trimming of a formed layer can be carried out.

8. An apparatus in accordance with claim 1, wherein a conveyor device (39) is provided which guides a completely formed layer into the cutting device (37) and out of it in the reverse direction.

9. An apparatus in accordance with claim 1, wherein a conveyor device (38, 38′, 39) is provided which guides a completely formed layer into the cutting device (36, 36′, 37) and out of it in the same direction.

10. An apparatus in accordance with claim 8, wherein the cutting plane of the cutting device (16, 36, 36′, 37) extends parallel to the conveying direction of the conveyor device (38, 38′, 39).

11. An apparatus in accordance with claim 9, wherein the cutting plane of the cutting device (16, 36, 36′, 37) extends parallel to the conveying direction of the conveyor device (38, 38′, 39).

12. An apparatus in accordance with claim 1, wherein a compression unit (60) is provided for the layer to be cut in the region of the cutting device.

13. An apparatus in accordance with claim 5, wherein a retractable buffer (48, 48′) is provided after the cutting device (36, 36′, 37) and above the rotation device (42, 46; 42′, 46′) with the aid of which a cut layer can be dropped into the rotation device.

14. A method for the combined stacking and cutting of paper products, in particular with an apparatus in accordance with one of the preceding claims, comprising the following steps:
a) conveying of a number of products of a product stream into a stacking chamber and forming of a layer of products;
b) conveying of the layer to a cutting device;
c) trimming of at least one side of the layer; and
d) discharging the layer from the apparatus.

15. A method in accordance with claim 13, wherein after step c), the layer is conveyed onto a rotation device and the rotation device is subsequently rotated through 180°.

16. A method in accordance with claim 13, wherein the product stream is cut at at least one side before conveying.

17. A method in accordance with claim 13, wherein the orientation of the products of the supplied product stream is turned through 90°—relative to the respective conveying direction—in comparison with the orientation of the layer during transport to the cutting device.
